(19) United States
(12) Patent Application Publication
(10) Pub. No.: US 2010/0195765 A1
(43) Pub. Date: Aug. 5, 2010

(54) RADIO FREQUENCY MODULATING CIRCUIT, AND TRANSMITTER HAVING THE SAME

(75) Inventors: Tsung-Hsien LIN, Taipei (TW); Yao-Hong LIU, Taipei City (TW)

Correspondence Address: FOLEY AND LARDNER LLP;SUITE 500, 3000 K STREET NW, WASHINGTON, DC, 20007, US

(73) Assignee: National Taiwan University

(21) Appl. No.: 12/472,067

(22) Filed: May 26, 2009

(30) Foreign Application Priority Data
Feb. 5, 2009 (TW) 098103653

(51) Int. Cl. H04L 27/20

(52) U.S. Cl. 375/308

(57) ABSTRACT

A radio frequency modulating circuit of a transmitter includes a phase multiplexer including a plurality of phase followers each coupled to a selector and operating in accordance with a corresponding pair of complementary-level carrier signals received thereby. The selector is operable to enable conduction of one of the phase followers therethrough in response to a data sequence modulated from a data stream by a phase shift keying modulating circuit. A conversion amplifier is operable in accordance with the complementary-level carrier signals of a conducting one of the phase followers so as to output a phase-modulated output corresponding to the data stream. The phase-modulated output is amplified by a power amplifier and is transmitted through an antenna.

### CROSS-REFERENCE TO RELATED APPLICATION

This application claims priority of Taiwanese Application No. 098103653, filed on Feb. 5, 2009.

### BACKGROUND OF THE INVENTION

1. Field of the Invention

The invention relates to modulation techniques, more particularly to a transmitter having a radio frequency modulating circuit.

2. Description of the Related Art

For real-time high-resolution image transmission with a maximum frame rate of 10 frames/sec, a data transmission rate of up to 10 Mbps is required in a wireless ultrasound capsule endoscope system.

FIG. 1 illustrates a conventional transmitter 900 that includes a phase shift keying (PSK) modulating circuit 91, two digital-to-analog (D/A) converters 92, two filters 93 coupled to the PSK modulating circuit 91, two filters 93 coupled respectively to the D/A converters 92, a radio frequency modulating circuit 94 coupled to the filters 93, a power amplifier 95 coupled to the radio frequency modulating circuit 94, and an antenna 96 coupled to the power amplifier 95. The PSK modulating circuit 91 modulates a data stream to be transmitted into an in-phase sequence and a quadrature sequence. Each digital-to-analog converter 92 receives a corresponding one of the in-phase sequence and the quadrature sequence from the PSK modulating circuit 91, and converts the same into an analog output. The analog output from each digital-to-analog converter 92 is filtered by a corresponding one of the filters 93. The radio frequency modulating circuit 94 modulates the filtered analog outputs from the filters 93 into a phase-modulated output corresponding to the data stream in accordance with four carrier signals (P0, P90, P180, P270) generated by a frequency synthesizer 97. The power amplifier 95 amplifies power of the phase-modulated output from the radio frequency modulating circuit 94. The antenna 96 transmits the phase-modulated output amplified by the power amplifier 95.

However, when enhancement of the transmission rate of the data stream is required, baseband bandwidth for the in-phase and quadrature sequences increases, thereby resulting in higher operating frequencies of the D/A converters 92 and the filters 93. As a result, power consumption of the D/A converters 92 and the filters 93 increase. Therefore, there is a trade-off between the data transmission rate and power consumption in the conventional transmitter 900. Furthermore, the conventional transmitter 900 has a plurality of analog circuit components that are sensitive to variations of process, operational voltage and temperature such that operating stability of the conventional transmitter 900 is easily interfered.

### SUMMARY OF THE INVENTION

Therefore, an object of the present invention is to provide a transmitter having a radio frequency modulating circuit that can overcome the aforesaid drawbacks of the prior art.

According to one aspect of the present invention, a transmitter comprises:

a phase shift keying (PSK) modulating circuit adapted for modulating a data stream to be transmitted into a modulated data sequence;

a radio frequency modulating circuit including
at least one phase multiplexer that includes
   a selector coupled to the PSK modulating circuit for receiving the modulated data sequence therefrom, and
   a plurality of phase followers coupled to the selector, each of the phase followers operating in accordance with a corresponding pair of complementary-level carrier signals received thereby,
   the selector being operable to enable conduction of one of the phase followers therethrough in response to the modulated data sequence from the PSK modulating circuit,
a conversion amplifier coupled to the phase followers of the phase multiplexer, and operable in accordance with the complementary-level carrier signals of a conducting one of the phase followers so as to output a phase-modulated output corresponding to the data stream, and
a power amplifier coupled to the conversion amplifier for receiving the phase-modulated output, and amplifying power of the phase-modulated output; and

an antenna coupled to the power amplifier for transmission of the phase-modulated output amplified by the power amplifier.

According to another aspect of the present invention, there is provided a radio frequency modulating circuit adapted for modulating a data sequence into a phase-modulated output. The radio frequency modulating circuit comprises:

at least one phase multiplexer that includes
a selector adapted for receiving the data sequence, and
a plurality of phase followers coupled to the selector, each of the phase followers operating in accordance with a corresponding pair of complementary-level carrier signals received thereby,
the selector being operable to enable conduction of one of the phase followers therethrough in response to the data sequence;

a conversion amplifier coupled to the phase followers of the phase multiplexer, and operable in accordance with the complementary-level carrier signals of a conducting one of the phase followers so as to output the phase-modulated output corresponding to the data sequence; and

a power amplifier coupled to the conversion amplifier for receiving the phase-modulated output therefrom, and amplifying power of the phase-modulated output.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic electrical circuit block diagram of a conventional transmitter;

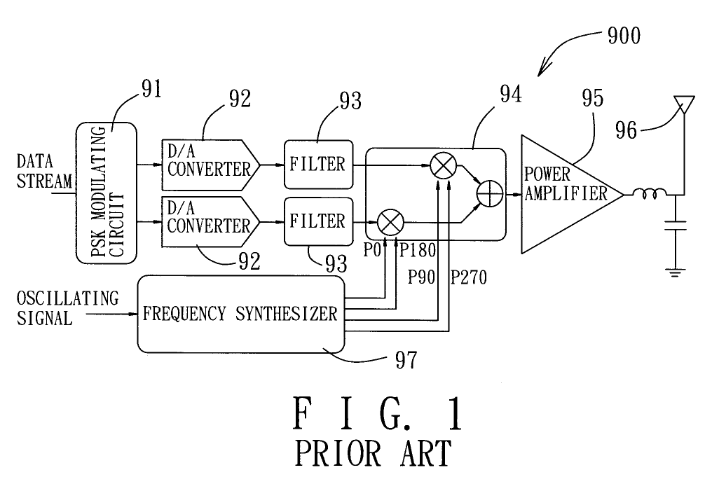

FIG. 2 is a schematic electrical circuit block diagram illustrating the first preferred embodiment of a transmitter according to the present invention;

FIGS. 3a to 3d are timing diagrams illustrating respectively four different carrier signals (P0, P90, P180, P270) generated by a frequency synthesizer of the first preferred embodiment;

FIG. 4 is a schematic electrical circuit diagram illustrating a radio frequency modulating circuit of the first preferred embodiment;

FIG. 5 is a constellation diagram illustrating offset quadrature phase shift keying modulation by a phase shift keying modulating circuit of the first preferred embodiment;

FIG. 6 is a schematic electrical circuit diagram illustrating a radio frequency modulating circuit of the second preferred embodiment of a transmitter according to the present invention; and

FIG. 7 is a schematic electrical circuit diagram illustrating a radio frequency modulating circuit of the third preferred embodiment of a transmitter according to the present invention.

### DETAILED DESCRIPTION OF THE PREFERRED EMBODIMENTS

Before the present invention is described in greater detail, it should be noted that like elements are denoted by the same reference numerals throughout the disclosure.

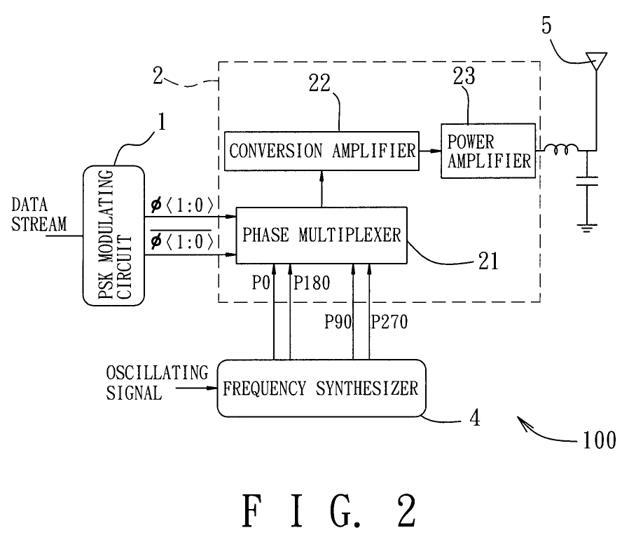

Referring to FIG. 2, the first preferred embodiment of a transmitter 100 according to the present invention is shown to include a phase shift keying (PSK) modulating circuit 1, a radio frequency modulating circuit 2, a frequency synthesizer 4, and an antenna 5.

The PSK modulating circuit 1 is adapted for modulating a data stream to be transmitted into a modulated data sequence in a known manner. In this embodiment, the PSK modulating circuit 1 is an offset quadrature phase shift keying (OQPSK) modulating circuit. The modulated data sequence includes two complementary-level in-phase sequences (φ [symbol] [symbol] , φ̅ [symbol] [symbol] ) and two complementary-level quadrature sequences (φ [symbol] 0 [symbol] φ [symbol] 0̅ [symbol] ). Each of the complementary-level in-phase sequences (φ [symbol] 1 [symbol] φ̅ [symbol] 1̅ [symbol] ) and the complementary-level quadrature sequences (φ [symbol] 0 [symbol] φ̅ [symbol] 0̅ [symbol] ) has a one-bit width, and a transmission rate of 7.5 MHz equal to half of that of the data stream.

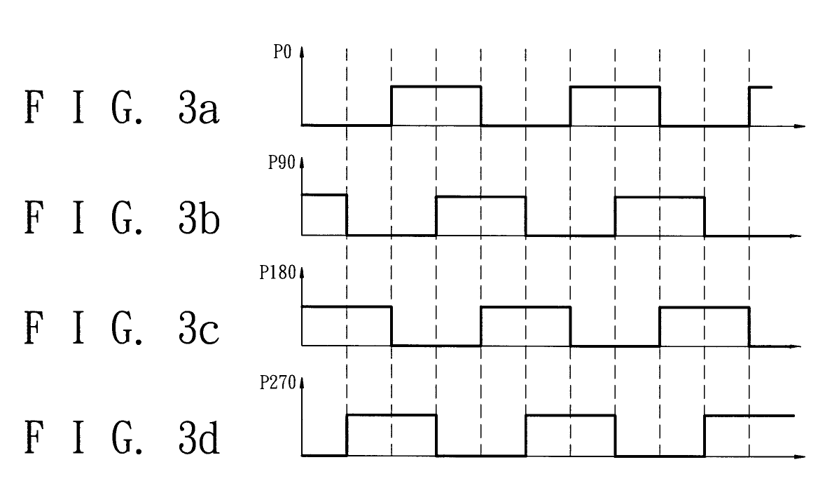

The frequency synthesizer 4, such as a multiphase local oscillator, is adapted to receive an oscillating signal, and generates four different carrier signals (P0, P90, P180, P270), as shown in FIGS. 3a to 3d based on the oscillating signal received thereby, wherein the carrier signals (P0, P180) are a pair of complementary-level carrier signals, and the carrier signals (P90, P270) are a pair of complementary-level carrier signals. Preferably, in this embodiment, each of the carrier signals (P0, P90, P180, P270) has a frequency of about 400 MHz suitable for human body signal propagation.

The radio frequency modulating circuit 2 includes a phase multiplexer 21 coupled to the PSK modulating circuit 1 and the frequency synthesizer 4, a conversion amplifier 22 coupled to the phase multiplexer 21, and a power amplifier 23 coupled to the conversion amplifier 22.

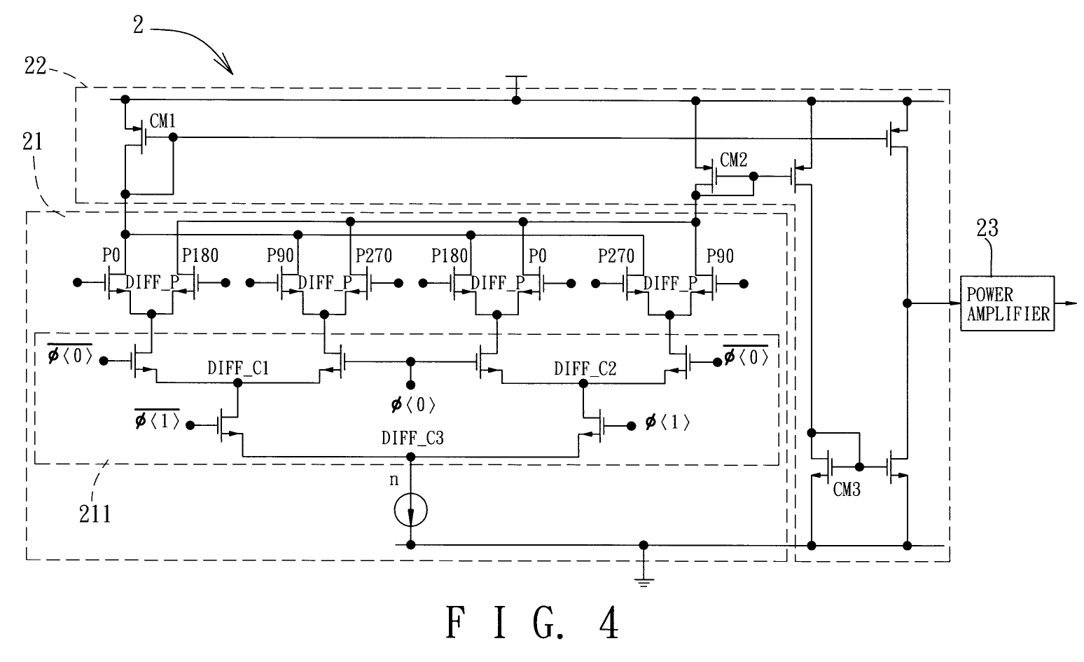

As shown in FIG. 4, the phase multiplexer 21 includes a selector 211 coupled to the PSK modulating circuit 1 for receiving the modulated data sequence therefrom, and four phase followers (DIFF_P) coupled to the selector 211. Each phase follower (DIFF_P) receives a corresponding pair of the complementary-level carrier signals (P0, 180), (P90, P270) from the frequency synthesizer 4, and operates in accordance with the corresponding pair of the complementary-level carrier signals (P0, 180), (P90, P270) received thereby. The selector 211 receives the complementary-level in-phase sequences (φ [symbol] 1 [symbol] φ̅ [symbol] 1̅ [symbol] ) and the complementary-level quadrature sequences (φ [symbol] 0 [symbol] φ̅ [symbol] 0̅ [symbol] ) from the PSK modulating circuit 1, and is operable to enable conduction of one of the phase followers (DIFF_P) therethrough in response to the complementary-level in-phase sequences (φ [symbol] 1 [symbol] φ̅ [symbol] [symbol] ) and the complementary-level quadrature sequences (φ [symbol] 0 [symbol] φ̅ [symbol] 0̅ [symbol] ) received thereby.

The conversion amplifier 22 is coupled to the phase followers (DIFF_P) of the phase multiplexer 2, and is operable in accordance with the complementary-level carrier signals (P0, 180), (P90, P270) of a conducting one of the phase followers (DIFF_P) so as to output a phase-modulated output corresponding to the data stream.

The power amplifier 23 receives the phase-modulated output from the conversion amplifier 22, and amplifies power of the phase-modulated output.

The antenna 5 is coupled to the power amplifier 23 for transmission of the phase-modulated output amplified by the power amplifier 23, as shown in FIG. 2.

In this embodiment, each phase follower (DIFF_P) of the phase multiplexer 21 of the radio frequency modulating circuit 2 includes a differential pair of first and second transistors having gates for receiving respectively the corresponding pair of the complementary-level carrier signals (P0, 180), (P90, P270). The selector 211 includes first, second and third selecting units (DIFF_C1, DIFF_C2, DIFF_C3). Each of the first and second selecting units (DIFF_C1, DIFF_C2) is coupled to two corresponding ones of the phase followers (DIFF_P), and is operable in response to the complementary-level quadrature sequences (φ [symbol] 0 [symbol] φ̅ [symbol] 0̅ [symbol] ). Each of the first and second selecting units (DIFF_C1, DIFF_C2) includes a differential pair of transistors having gates for receiving respectively the complementary-level quadrature sequences (φ [symbol] 0 [symbol] φ̅ [symbol] 0̅ [symbol] ), drains coupled respectively to the two corresponding ones of the phase followers (DIFF_P), and sources coupled to each other. The third selecting unit (DIFF_C3) is coupled between a reference node (n) and the first and second selecting units (DIFF_C1, DIFF_C2), and is operable in response to the complementary-level in-phase sequences (φ [symbol] 1 [symbol] φ̅ [symbol] 1̅ [symbol] ). The third selecting unit (DIFF_C3) includes a differential pair of transistors having gates for receiving respectively the complementary-level in-phase sequences (φ [symbol] 1 [symbol] φ̅ [symbol] 1̅ [symbol] ), drains coupled respectively to the first and second selecting units (DIFF_C1, DIFF_C2), and sources coupled to the reference node (n). One of the first and second selecting units (DIFF_C1, DIFF_C2) coupled to the conducting one of the phase followers (DIFF_P) is operable to establish electrical connection between the conducting one of the phase followers (DIFF_P) and the third selecting unit (DIFF_C3) therethrough in response to the complementary-level quadrature sequences (φ [symbol] 0 [symbol] φ̅ [symbol] 0̅ [symbol] ). The third selecting unit (DIFF_C3) is operable to establish electrical connection between the reference node (n) and said one of the first and second selecting units (DIFF_C1, DIFF_C2) therethrough in response to the complementary-level in-phase sequences (φ [symbol] 1 [symbol] φ̅ [symbol] [symbol] ) such that the conducting one of the phase followers (DIFF_P) is connected to the reference node (n) through said one of the first and second selecting units (DIFF_C1, DIFF_C2) and the third selecting unit (DIFF_C3). In this embodiment, the reference node (n) is coupled to ground through a current source.

In this embodiment, the conversion amplifier 22 includes a first current mirror (CM1) coupled to drains of the first transistors of the phase followers (DIFF_P), a second current mirror (CM2) coupled to drains of the second transistors of the phase followers (DIFF_P), and a third current mirror (CM3) coupled among the first and second current mirrors (CM1, CM2) and ground.

When the first transistor of the conducting one of the phase followers (DIFF_P) conducts in response to the respective one of the complementary-level carrier signals (P0, 180), (P90, P270), the first current mirror (CM1) is operable so that the phase-modulated output outputted by the conversion amplifier 22 has a high level. When the second transistor of the conducting one of the phase followers (DIFF_P) conducts in response to the other one of the complementary-level carrier signals (P0, 180), (P90, P270), the second current mirror (CM2) is operable so that the phase-modulated output outputted by the conversion amplifier 22 has a low level.

For example, when φ [symbol] 1:0 [symbol] =00, the selector 211 is operable such that a leftmost phase follower (DIFF_P) of FIG. 4 conducts, and the conversion amplifier 22 is operable in accordance with the complementary-level carrier signals (P0, 180) of the leftmost phase follower (DIFF_P). Thus, when the carrier signal (P0) has a high level while the carrier signal (180) has a low level, the first transistor of the leftmost phase follower (DIFF_P) conducts such that the first current mirror (CM1) is operable so that the phase-modulated output has the high level. On the other hand, when the carrier signal (P180) has a high level while the carrier signal (P0) has a low level, the second transistor of the leftmost phase follower (DIFF_P) conducts such that the second current mirror (CM2) is operable so that the phase-modulated output has the low level. Therefore, when φ [symbol] 1:0 [symbol] =00, the level of the phase-modulated output follows that of the carrier signal (P0).

Similarly, when φ [symbol] 1:0 [symbol] =01, the level of the phase-modulated output follows that of the carrier signal (P90). When φ [symbol] 1:0 [symbol] =11, the level of the phase-modulated output follows that of the carrier signal (P180). When φ [symbol] 1:0 [symbol] =10, the level of the phase-modulated output follows that of the carrier signal (P270).

It is noted that each of the first, second and third selecting units (DIFF_C1, DIFF_C2, DIFF_C3) and the phase followers (DIFF_P) is embodied as a differential pair. Since a difference between high and low levels of each of the sequences (φ [symbol] 1:0 [symbol] φ̅ [symbol] 1̅:̅0̅ [symbol] ), generated by the PSK modulating circuit 1 is large enough to trigger one transistor of a respective one of the first, second and third selecting units (DIFF_C1, DIFF_C2, DIFF_C3) into conduction and to cut off the other transistor of the same, the selector 211 is capable of effective conduction of one of the phase followers (DIFF_P) therethrough. Furthermore, since a difference between high and low levels of each of the carrier signals (P0, P90, P180, P270) generated by the frequency synthesizer 4 is large enough to trigger only one of the first and second transistors of a respective one of the phase followers (DIFF_P) into conduction at any time, the level of the phase-modulated output can accurately follow a corresponding one of the carrier signals (P0, P90, P180, P270). Therefore, the radio frequency modulating circuit 2 can operate with a high data transmission rate. Moreover, since such a differential pair has a relatively small operating current that is lower than 0.4 mA in this embodiment, the radio frequency modulating circuit 2 has relatively low power consumption.

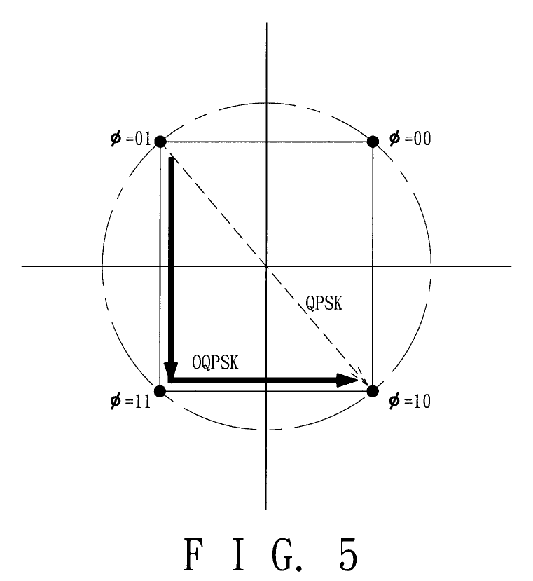

Since the PSK modulating circuit 1 is an OQPSK modulating circuit in this embodiment, transition points of the in-phase sequence (φ [symbol] 1 [symbol] ) and the quadrature sequence (φ [symbol] 0 [symbol] ) are staggered. In other words, at any time, transition of at most one of the in-phase sequence (φ [symbol] 1 [symbol] ) and the quadrature sequence (φ [symbol] 0 [symbol] ) occurs. For example, if φ [symbol] 1:0 [symbol] generated currently by the PSK modulating circuit 1 is “01”, a next transition will be “01”, “00” or “00” rather than “10”, as shown in FIG. 5. Therefore, envelope variation of the phase-modulated output can be effectively controlled, and linearity requirement for the power amplifier 23 is reduced. Since the phase-modulated output has fixed-amplitude characteristics, the power amplifier 23 can be non-linear. As such, the power amplifier 23 is a digital inverter in this embodiment.

However, in other embodiments, the PSK modulating circuit 1 can be a QPSK modulating circuit, and the in-phase sequence (φ [symbol] 1 [symbol] ) and the quadrature sequence (φ [symbol] 0 [symbol] ) may have the same transition point. That is, if φ [symbol] 1:0 [symbol] generated currently by the PSK modulating circuit 1 is “01”, the next transition will be “01”, “00”, “11” or “10”, as shown in FIG. 5. Alternatively, the PSK modulating circuit 1 can also be an M-PSK modulating circuit, where M=2^{2W}, and W is a positive integer.

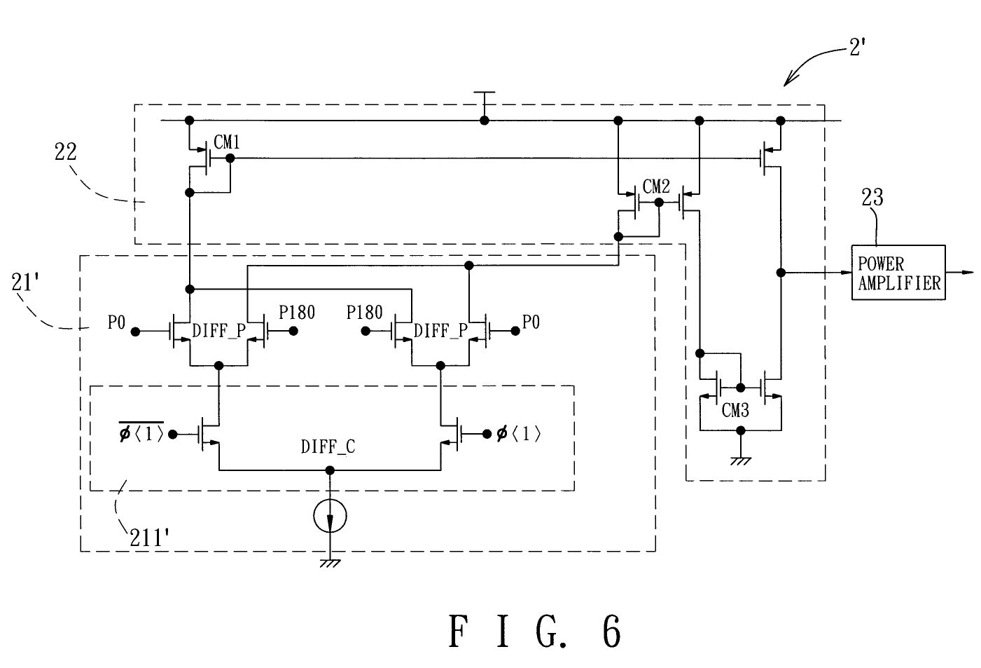

FIG. 6 illustrates the radio frequency modulating circuit 2′ of the second preferred embodiment of a transmitter according to this invention, which is a modification of the first preferred embodiment. In this embodiment, the PSK modulating circuit (not shown) is a binary phase shift keying (BPSK) modulating circuit such that the modulated data sequence from the PSK modulating circuit includes the complementary-level in-phase sequences (φ [symbol] 1 [symbol] φ̅ [symbol] 1̅ [symbol] ), and only the complementary-level carrier signals (P0, P180) are generated by the frequency synthesizer (not shown).

The radio frequency modulating circuit 2′ of the second preferred embodiment differs from that of the first preferred embodiment in that the phase multiplexer 21′ includes two of the phase followers (DIFF_P) and that the selector 211′ includes a differential pair of transistors. Each phase follower (DIFF_P) operates in accordance with the carrier signals (P0, P180) received thereby. The transistors of the selector 211′ have gates coupled to the PSK modulating circuit for receiving respectively the complementary-level in-phase sequences (φ [symbol] 1 [symbol] φ̅ [symbol] 1̅ [symbol] ) therefrom, drains coupled respectively to the phase followers (DIFF_P), and sources coupled to each other. One of the transistors of the selector 211′ coupled to the conducting one of the phase followers (DIFF_P) conducts in response to the respective one of the complementary-level in-phase sequences (φ [symbol] 1 [symbol] φ̅ [symbol] 1̅ [symbol] ) received thereby.

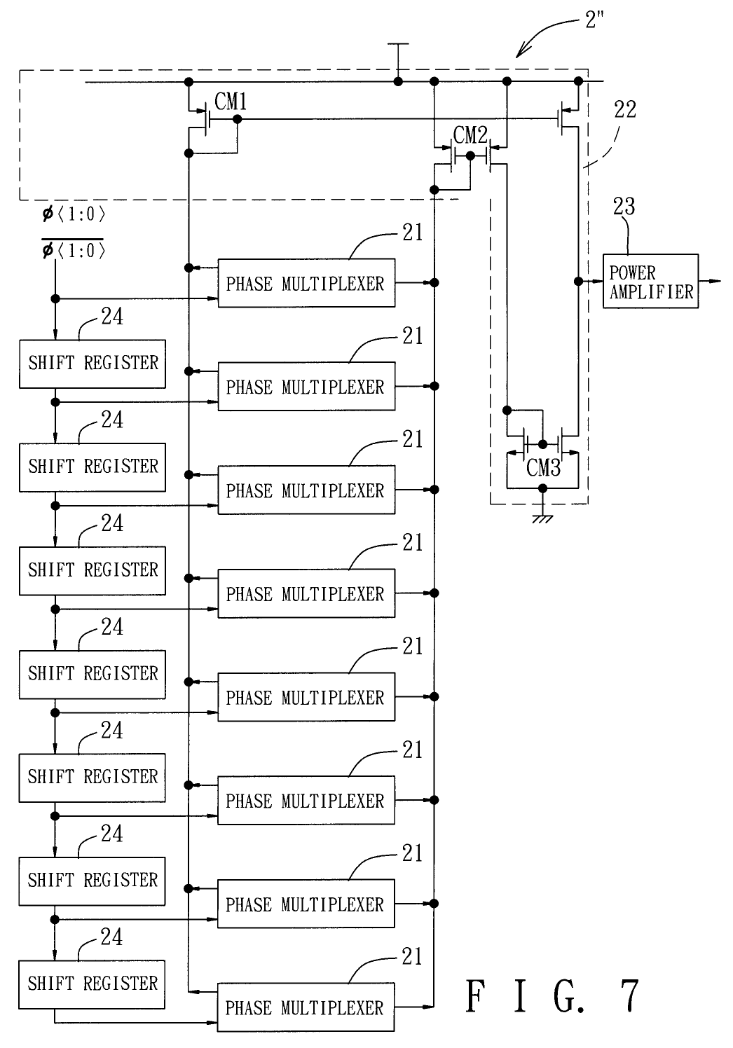

FIG. 7 illustrates the radio frequency modulating circuit 2″ of the third preferred embodiment of a transmitter according to this invention, which is a modification of the first preferred embodiment.

In this embodiment, the radio frequency modulating circuit 2″ includes a parallel connection of a number (K+1) of the phase multiplexers 21 coupled to the conversion amplifier 22, where K=2^{Y}−1, and Y is a positive integer. For example, Y is 3, and K is 7. The selector of a first one of the phase multiplexers 21 is coupled to the PSK modulating circuit for receiving the sequences (φ [symbol] 1:0 [symbol] φ̅ [symbol] 1̅:̅0̅ [symbol] ) therefrom.

The radio frequency modulating circuit 2″ further includes a series connection of a number (K) of shift registers 24. Each shift register 24 has an input end and an output end. The output end of a j^{th} one of the shift registers 24 is coupled to the selector of a (j+1)^{th} one of the phase multiplexers 21, where 1≦j≦K. Each shift register 24 receives an input signal through the input end thereof, and subsequently outputs the input signal received thereby to the selector of a corresponding one of the phase multiplexers through the output end thereof after a time delay. The sequences (φ [symbol] 1:0 [symbol] φ̅ [symbol] 1̅:̅0̅ [symbol] ) from the PSK modulating circuit serve as the input signal received by a first one of the shift registers 24.

In this embodiment, the PSK modulating circuit is an OQPSK modulating circuit, and K=7. A transmission rate of the sequences (φ [symbol] 1:0 [symbol] φ̅ [symbol] 1̅:̅0̅ [symbol] ) generated by the PSK modulating circuit is 7.5 MHz (=1/T). It is noted that a reciprocal of the time delay is equal to (K+1) times a switching frequency of the sequences (φ [symbol] 1:0 [symbol] φ̅ [symbol] 1̅:̅0̅ [symbol] ). Therefore, the operating frequency of each shift register 24 is (K+1)/T=8/T=60 MHz. The greater the number K, the less will be the variation of the phase of the phase-modulated output within each time delay.

The shift registers 24 and the phase multiplexers 21 constitute a finite impulse response (FIR) architecture that can achieve averaging phase variation effect to reduce a phase variation rate of the phase-modulated output, thereby reducing transmission bandwidth.

In sum, since the radio frequency modulating circuit 2, 2′, 2″ directly receives the sequences (φ [symbol] 1:0 [symbol] φ̅ [symbol] 1̅:̅0̅ [symbol] ) each being in a digital format, the digital-to-analog converters 92 and the filters 93 in the conventional transmitter 900 can be omitted. Therefore, the transmitter 100 of the present invention has lower power consumption and is less sensitive to variations of process, operating voltage and temperature. Furthermore, the phase multiplexer 21, 21′ permits a high data transmission rate, and reduces linearity requirement for the power amplifier 23.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A transmitter comprising:
a phase shift keying (PSK) modulating circuit adapted for modulating a data stream to be transmitted into a modulated data sequence;
a radio frequency modulating circuit including
at least one phase multiplexer that includes
a selector coupled to said PSK modulating circuit for receiving the modulated data sequence therefrom, and
a plurality of phase followers coupled to said selector, each of said phase followers operating in accordance with a corresponding pair of complementary-level carrier signals received thereby,
said selector being operable to enable conduction of one of said phase followers therethrough in response to the modulated data sequence from said PSK modulating circuit,
a conversion amplifier coupled to said phase followers of said phase multiplexer, and operable in accordance with the complementary-level carrier signals of a conducting one of said phase followers so as to output a phase-modulated output corresponding to the data stream, and
a power amplifier coupled to said conversion amplifier for receiving the phase-modulated output therefrom, and amplifying power of the phase-modulated output; and
an antenna coupled to said power amplifier for transmission of the phase-modulated output amplified by said power amplifier.

2. The transmitter as claimed in claim 1, wherein:
each of said phase followers of said phase multiplexer includes a differential pair of first and second transistors having gates for receiving respectively the complementary-level carrier signals; and
said conversion amplifier includes a first current mirror coupled to drains of said first transistors of said phase followers, and a second current mirror coupled to drains of said second transistors of said phase followers;
when said first transistor of said conducting one of said phase followers conducts in response to the respective one of the complementary-level carrier signals, said first current mirror is operable so that the phase-modulated output outputted by said conversion amplifier has a high level; and
when said second transistor of said conducting one of said phase followers conducts in response to the other one of the complementary-level carrier signals, said second current mirror is operable so that the phase-modulated output outputted by said conversion amplifier has a low level.

3. The transmitter as claimed in claim 1, wherein:
the modulated data sequence from said PSK modulating circuit includes two complementary-level in-phase sequences;
said phase multiplexer of said radio frequency modulating circuit includes two of said phase followers;
said selector of said phase multiplexer of said radio frequency modulating circuit includes a differential pair of transistors having gates coupled to said PSK modulating circuit for receiving respectively the complementary-level in-phase sequences therefrom, drains coupled respectively to said phase followers, and sources that are coupled to each other; and
one of said transistors of said selector coupled to said conducting one of said phase followers conducts in response to the respective one of the complementary-level in-phase sequences received thereby.

4. The transmitter as claimed in claim 1, wherein:
the modulated data sequence from said PSK modulating circuit includes two complementary-level in-phase sequences and two complementary-level quadrature sequences;
said phase multiplexer of said radio frequency modulating circuit includes four of said phase followers;
said selector of said phase multiplexer of said radio frequency modulating circuit includes first, second and third selecting units, each of said first and second selecting units being coupled to two corresponding ones of said phase followers and being operable in response to the complementary-level quadrature sequences, said third selecting unit being coupled between a reference node and said first and second selecting units, and being operable in response to the complementary-level in-phase sequences; and
one of said first and second selecting units coupled to said conducting one of said phase followers is operable to establish electrical connection between said conducting one of said phase followers and said third selecting unit therethrough in response to the complementary-level quadrature sequences, said third selecting unit being operable to establish electrical connection between the reference node and said one of said first and second selecting units therethrough in response to the complementary-level in-phase sequences such that said conducting one of said phase followers is connected to the reference node through said one of said first and second selecting units and said third selecting unit.

5. The transmitter as claimed in claim 1, wherein:
said radio frequency modulating circuit includes a parallel connection of a number (K+1) of said phase multiplexers coupled to said conversion amplifier, where K=2^{Y}−1, and Y is a positive integer, said selector of a first one of said phase multiplexers being coupled to said PSK modulating circuit for receiving the modulated data sequence therefrom;
said radio frequency modulating circuit further includes a series connection of a number (K) of shift registers each having an input end and an output end, said output end of a j^{th} one of said shift registers being coupled to said selector of a (j+1)^{th} one of said phase multiplexers, where 1≦j≦K, each of said shift registers receiving an input signal through said input end thereof, and subsequently outputting the input signal received thereby to said selector of a corresponding one of said phase multiplexers through said output end thereof after a time delay, the modulated data sequence from said PSK modulating circuit serving as the input signal received by a first one of said shift registers; and
a reciprocal of the time delay is equal to (K+1) times a switching frequency of the modulated data sequence.

6. The transmitter as claimed in claim 1, further comprising a frequency synthesizer for generating the complementary-level carrier signals for each of said phase followers.

7. The transmitter as claimed in claim 1, wherein said power amplifier is a digital inverter.

8. A radio frequency modulating circuit adapted for modulating a data sequence into a phase-modulated output, said radio frequency modulating circuit comprising:
at least one phase multiplexer that includes
a selector adapted for receiving the data sequence, and
a plurality of phase followers coupled to said selector, each of said phase followers operating in accordance with a corresponding pair of complementary-level carrier signals received thereby,
said selector being operable to enable conduction of one of said phase followers therethrough in response to the data sequence;
a conversion amplifier coupled to said phase followers of said phase multiplexer, and operable in accordance with the complementary-level carrier signals of a conducting one of said phase followers so as to output the phase-modulated output corresponding to the data sequence; and
a power amplifier coupled to said conversion amplifier for receiving the phase-modulated output, and amplifying power of the phase-modulated output.

9. The radio frequency modulating circuit as claimed in claim 8, wherein:
each of said phase followers of said phase multiplexer includes a differential pair of first and second transistors having gates adapted for receiving respectively the complementary-level carrier signals; and
said conversion amplifier includes a first current mirror coupled to drains of said first transistors of said phase followers, and a second current mirror coupled to drains of said second transistors of said phase followers;
when said first transistor of said conducting one of said phase followers conducts in response to the respective one of the complementary-level carrier signals, said first current mirror is operable so that the phase-modulated output outputted by said conversion amplifier has a high level; and
when said second transistor of said conducting one of said phase followers conducts in response to the other one of the complementary-level carrier signals, said second current mirror is operable so that the phase-modulated output outputted by said conversion amplifier has a low level.

10. The radio frequency modulating circuit as claimed in claim 8, the data sequence including two complementary-level in-phase sequences, wherein:
said phase multiplexer includes two of said phase followers;
said selector of said phase multiplexer includes a differential pair of transistors having gates adapted for receiving respectively the complementary-level in-phase sequences, drains coupled respectively to said phase followers, and sources that are coupled to each other; and
one of said transistors of said selector coupled to said conducting one of said phase followers conducts in response to the respective one of the complementary-level in-phase sequences received thereby.

11. The radio frequency modulating circuit as claimed in claim 8, the data sequence including two complementary-level in-phase sequences and two complementary-level quadrature sequences, wherein:
said phase multiplexer includes four of said phase followers;
said selector of said phase multiplexer includes first, second and third selecting units, each of said first and second selecting units being coupled to two corresponding ones of said phase followers and being operable in response to the complementary-level quadrature sequences, said third selecting unit being coupled between a reference node and said first and second selecting units, and being operable in response to the complementary-level in-phase sequences; and
one of said first and second selecting units coupled to said conducting one of said phase followers is operable to establish electrical connection between said conducting one of said phase followers and said third selecting unit therethrough in response to the complementary-level quadrature sequences, said third selecting unit being operable to establish electrical connection between the reference node and said one of said first and second selecting units therethrough in response to the complementary-level in-phase sequences such that said conducting one of said phase followers is connected to the reference node through said one of said first and second selecting units and said third selecting unit.

12. The radio frequency modulating circuit as claimed in claim 8, comprising a parallel connection of a number (K+1) of said phase multiplexers coupled to said conversion amplifier, where K=2^{Y}−1, and Y is a positive integer, said selector of a first one of said phase multiplexers being adapted to receive the data sequence; said radio frequency modulating circuit further comprising a series connection of a number (K) of shift registers each having an input end and an output end, said output end of a j^{th} one of said shift registers being coupled to said selector of a (j+1)^{th} one of said phase multiplexers, where 1≦j≦K, each of said shift registers being capable of receiving an input signal through said input end thereof, and subsequently outputting the input signal received thereby to said selector of a corresponding one of said phase multiplexers through said output end thereof after a time delay, the data sequence serving as the input signal received by a first one of said shift registers;
wherein a reciprocal of the time delay is equal to (K+1) times a switching frequency of the data sequence.

13. The radio frequency modulating circuit as claimed in claim 8, wherein said power amplifier is a digital inverter.
